(19) United States
(12) Patent Application Publication
(10) Pub. No.: US 2024/0235205 A1
(43) Pub. Date: Jul. 11, 2024

(54) CONTROL UNIT FOR CONTROLLING A FLOW OF ELECTRICAL ENERGY BETWEEN ONE OR MORE ELECTRICAL ENERGY REPOSITORIES AND A POWER GRID

(71) Applicant: Scania CV AB, Södertälje (SE)

(72) Inventor: Lianhao YIN, Stockholm (SE)

(73) Assignee: Scania CV AB, Södertälje (SE)

(21) Appl. No.: 18/285,881

(22) PCT Filed: Apr. 5, 2022
(86) PCT No.: PCT/SE2022/050333

§ 371 Date: Oct. 6, 2023

(30) Foreign Application Priority Data
Apr. 15, 2021 (SE) 2150462-6

(51) Int. Cl. H02J 3/32; B60L 53/64; B60L 55/00

(52) U.S. Cl. CPC H02J 3/322; B60L 53/64; B60L 55/00; H02J 2203/20

(57) ABSTRACT

A method is disclosed for controlling flow of electrical energy between electrical energy repositories each coupled to a respective internal load and a power grid, the method comprising charging the electrical energy repositories based on a set of parameters using energy drawn from the power grid to charge the electrical energy repositories, to a respective first threshold level of energy indicated by the set of parameters, controlling a flow of energy to the power grid using the set of parameters, wherein energy is drawn from any of the electrical energy repositories in a first period between a respective first time, indicative of when the respective first threshold level of energy is reached, and a respective second time, indicative of when energy is expected to be drawn from the one or more electrical energy repositories to the respective internal load, wherein the set of parameters is determined using a trained model.

### TECHNICAL FIELD

The present invention relates to a method controlling a flow of energy between energy repositories and a power grid. The invention further relates to a control unit, a vehicle, a supply unit, a cloud server, a computer program product, and a computer-readable storage medium.

### BACKGROUND

In today's world, the use of electricity is increasing with the use of more electrically powered devices. A large number of these electrically powered devices comprise electrical energy repositories, e.g., batteries. Examples of such devices are electrical or hybrid vehicles, which typically comprises a repository, such as a battery, used to power an internal drive unit used to move the vehicle to any target location.

Such electrically powered devices are typically charged using a power grid, e.g., a national or regional power grid, providing utility electricity.

A typical behavior for users of such electrical devices is to plug in the device when becoming stationary, e.g., when arriving at work or when arriving at home. This means that a large number of devices are plugged into the power grid during peak hours.

A problem with such user behavior is that it may lead to overload or capacity shortage of the power grid during peak hours.

A further problem is that electrical energy repositories are typically brought to a fully charged state, even though only a fraction of the charge will be needed to complete scheduled tasks. This may cause unwanted wear on the batteries and decrease the life span of the batteries.

Thus, there is a need for an improved method of controlling a flow of electrical energy between one or more electrical energy repositories and a power grid.

### OBJECTS OF THE INVENTION

An objective of embodiments of the present invention is to provide a solution which mitigates or solves the drawbacks described above.

### SUMMARY OF THE INVENTION

The above and further objectives are achieved by the subject matter described herein. Further advantageous implementation forms of the invention are described herein.

According to a first aspect of the invention objects of the invention are achieved by a method performed by a control unit for controlling a flow of electrical energy between one or more electrical energy repositories and a power grid. Each of the one or more electrical energy repositories is electrically coupled to a respective internal load, the method comprises charging the one or more electrical energy repositories, wherein the repositories are charged based on a set of parameters, wherein energy is drawn from the power grid to charge the one or more electrical energy repositories, wherein the one or more electrical energy repositories are charged to a respective first threshold level of energy, wherein the first respective threshold level of energy is indicated by the set of parameters, controlling a flow of energy to the power grid, wherein the flow of energy is controlled using the set of parameters, wherein energy is drawn from any of the one or more electrical energy repositories to the power grid, wherein energy is drawn from any of the energy repositories in a first period between a respective first time, indicative of when the respective first threshold level of energy is reached, and a respective second time, indicative of when energy is expected to be drawn from the one or more electrical energy repositories to the respective internal load, wherein the set of parameters is determined using a trained model.

At least one advantage of the first aspect of the invention is that lifespans of the electrical energy repositories are extended as they are only charged to a required level of energy. A further advantage is that overload or capacity shortage of the power grid can be reduced, e.g., during peak hours.

According to a second aspect of the invention objects of the invention are achieved by a control unit configured to control flow of electrical energy between one or more electrical energy repositories and a power grid, the control unit comprising a processor, and a memory, said memory containing instructions executable by said processor, wherein said control unit is configured to perform the method according to the first aspect.

According to a third aspect of the invention objects of the invention are achieved by a vehicle comprising the control unit according to the second aspect.

According to a fourth aspect of the invention objects of the invention are achieved by supply equipment, comprising the control unit according to the second aspect.

According to a fifth aspect of the invention objects of the invention are achieved by a cloud server comprising the control unit according to the second aspect.

According to a sixth aspect of the invention objects of the invention are achieved by a computer program product comprising instructions which, when the instructions of the program is executed by a computer, cause the computer to carry out the method according to the first aspect.

According to a seventh aspect of the invention the objects of the invention is achieved by a computer-readable storage medium comprising instructions which, when executed by a computer, cause the computer to carry out the steps of the method according to the first aspect.

The advantages of the second to seventh aspects are at least the same as for the first aspect.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates various devices coupled to a power grid according to one or more embodiments of the present disclosure.

FIG. 2 illustrates a level of energy over time stored in a plurality of electrical energy repositories according to one or more embodiments of the present disclosure.

FIG. 3 illustrates examples of characteristics of the one or more electrical energy repositories according to one or more embodiments of the present disclosure.

FIG. 4A-D schematically illustrates a method according to one or more embodiments of the present disclosure.

FIG. 5 illustrates an embodiment where a first threshold level of energy is selected equal to a second threshold level of energy.

FIG. 6 illustrates an embodiment where the first threshold level of energy is selected greater than the second threshold level of energy.

FIG. 7 illustrates an embodiment where the first threshold level of energy is selected less than the second threshold level of energy.

FIG. 8A-B illustrates embodiments with and without delay between the flow of energy from an electrical energy repository to the power grid.

FIG. 9 illustrates a control system for controlling a flow of electrical energy between one or more electrical energy repositories and a power grid.

FIG. 10 shows a control unit according to one or more embodiments of the present disclosure.

FIG. 11 shows a flowchart of a method for controlling a flow of electrical energy between one or more electrical energy repositories and a power grid according to one or more embodiments of the present disclosure.

FIG. 12 illustrates a trained model according to one or more embodiments of the present disclosure.

A more complete understanding of embodiments of the invention will be afforded to those skilled in the art, as well as a realization of additional advantages thereof, by a consideration of the following detailed description of one or more embodiments. It should be appreciated that like reference numerals are used to identify like elements illustrated in one or more of the figures.

### DETAILED DESCRIPTION

The present disclosure relates to increasing life span of electrical repositories, e.g., Lithium batteries in a vehicle. Life span of a battery is defined herein as a number of discharge/charge cycles where the battery maintains an acceptable performance or capacity. The performance or capacity is often defined as a relation between an initial capacity and a capacity after a given number of discharge/charge cycles. A battery may for example be labelled with 100 Ampere hours, Ah, and after the given number of discharge/charge cycles can only deliver 50 Ah.

Research shows that, in the example of Lithium-ion batteries, very important to a life span of a battery is Depth of Discharge, DoD or how much energy is drained before the battery is charged again. Equally important is charge and discharge bandwidths, I.e., cycling between 85 and 25 percent State of Charge, SoC, provides a longer life span than charging to 100 percent and discharging to 50 percent. Further important factors are selection of peak charge voltage, temperature. Additionally, dwelling in a full state-of-charge for an extended time reduces life span of the battery.

The present disclosure leverages knowledge of the above factors to optimize life span of the repository or battery.

In one example, the disclosure limits the DoD when providing power to a utility grid and thereby increases life span of the battery compared to do full discharge of the battery down to 0% capacity. In another example, a relatively narrow charge and discharge bandwidth is used to increase life span of the battery, e.g., operating the battery with a maximum SoC of 80% and a minimum SoC of 25% instead of operating the battery with a maximum SoC of 100% and a minimum SoC of 50%, which is common in conventional solutions. In one further example, the battery temperature is kept below 30° C. to increase life span of the battery, e.g., by limiting charging current to a normal/healthy charging current. The faster the battery is charged (relatively high charging current, the more heat is generated in the cells of the battery. In one further example, charging the battery to high levels of SoC is avoided if it is known that the vehicle will dwell for a long time. For example, knowing that a vehicle is not scheduled to operate for a longer period.

An “or” in this description and the corresponding claims is to be understood as a mathematical OR which covers “and” and “or”, and is not to be understand as an XOR (exclusive OR). The indefinite article “a” in this disclosure and claims is not limited to “one” and can also be understood as “one or more”, i.e., plural.

In the present disclosure, the expression “control unit” denotes a unit comprising processor, and a memory, said memory containing instructions executable by said processor, wherein said control unit is configured to perform the method described herein. The control unit is typically capable of receiving input data that is comprised in control signals, and to control other units by sending commands comprised in control signals. In one example, the control unit is a general-purpose computer or an Electric Control Unit, ECU.

In the present disclosure, the expressions “electrical energy repository”, “energy repository” or “repository” are used interchangeably and denotes a unit capable of storing electric energy. Examples of such electrical energy repositories are accumulators, batteries, or any other suitable device for storing electric energy.

In the present disclosure, the expression “internal load” denotes a consumer of electric energy, e.g., comprised in an electric device, which is electrically coupled to a respective electrical energy repository. Example of internal loads are electric machines used to drive a vehicle. I.e., typically, an electric motor and associated circuitry.

In the present disclosure, the expression “trained model” denotes a model configured to receive input data and generate output data, and which comprises adaptable functions or neural networks that can be trained using a training data set. Training a model signifies the step of producing a model from a training set, by using machine learning. In one example this involves obtaining a training data set, having both predetermined input values and predetermined output values. The model may then be trained/adapted using machine learning, e.g., supervised learning, by repeatedly providing the input values to candidate models and registering model output values and calculating performance measure for each candidate model based on the training output values and model output values. The candidate model producing the highest performance measure is then selected as the trained model. In one example, the candidate models represent neural networks with different weights assigned to neurons in the neural network. In further examples supervised classification methods such as Support Vector Machines, Naive Bayes and k-Nearest Neighbour may be used.

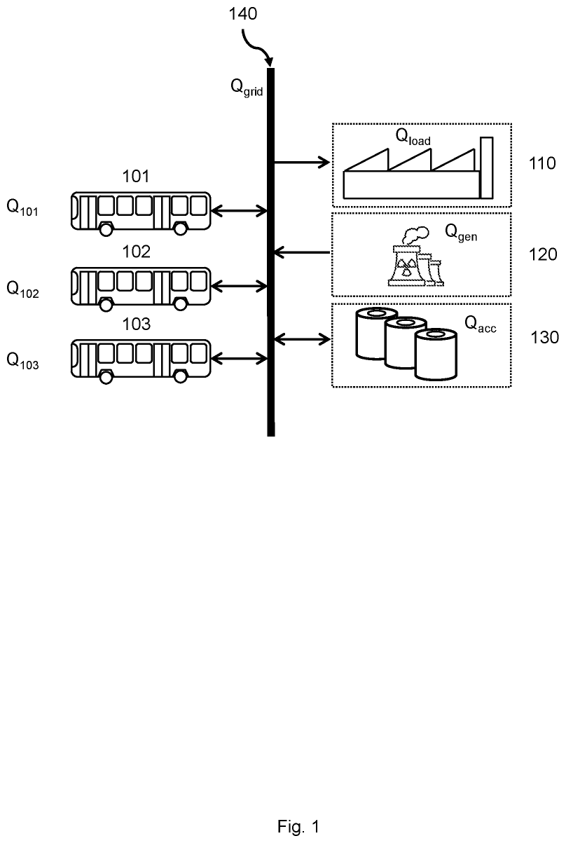

FIG. 1 illustrates various devices coupled to a power grid 140 according to one or more embodiments of the present disclosure. As can be seen in FIG. 1, one or more energy consumers 110 may be electrically coupled to the power grid 140. An energy consumer 110 may e.g., be a factory, office or household comprising electrical devices. Further, one or more energy generators 120, may be electrically coupled to the power grid 140. Examples of energy generators 120 may e.g., be nuclear power plants, solar power plants etc. Further, one or more electrical energy repositories 101, 102, 103, 130 may be electrically coupled to the power grid 140. The electrical energy repositories 101, 102, 103, 130 may e.g., be electrical vehicles 101-103 provided with batteries or accumulator packs 130.

As can be seen in FIG. 1, energy Q_{load} is typically flowing from the grid to the one or more energy consumers 110. Energy Q_{gen} is typically flowing to the grid from the one or more energy generators 120. Energy Q₁₀₁, Q₁₀₂, Q₁₀₃, Q_{acc} is typically flowing both to and from the grid to/from the one or more electrical energy repositories 101, 102, 103, 130.

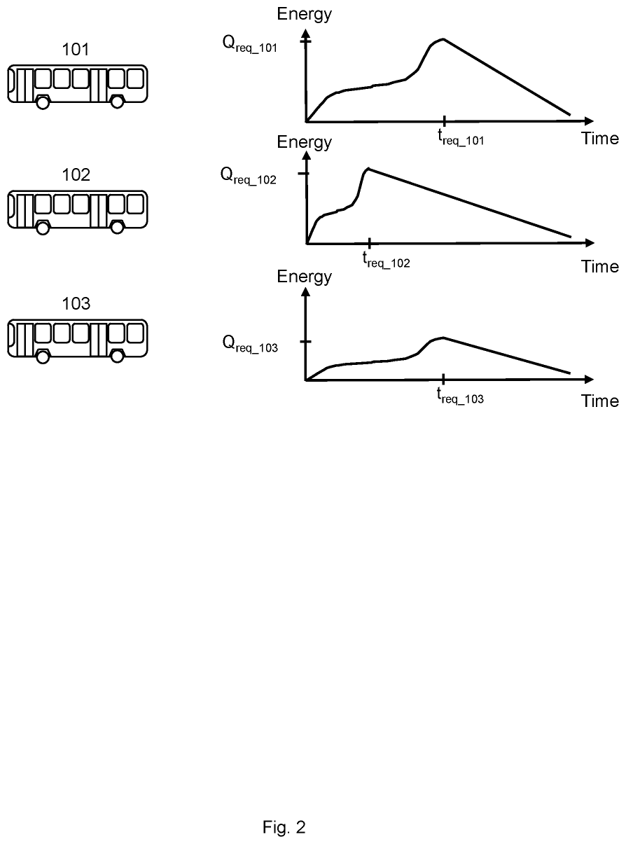

FIG. 2 illustrates a level of energy over time stored in a plurality of electrical energy repositories 101, 102, 103 according to one or more embodiments of the present disclosure. Each of the electrical energy repositories 101, 102, 103 may be provided with an internal load, e.g., a drive unit of a vehicle. Each electrical energy repository 101, 102, 103 and respective internal load is associated to a time schedule defining a period/periods when the internal load draws energy from the respective electrical energy repository, e.g., to complete scheduled tasks. This period/s typically has a start point in time t_{req_101}, t_{req_102}, t_{req_103} and an end point in time. Each electrical energy repository 101, 102, 103 and respective internal load have an estimated level of energy Q_{req_101}, Q_{req_102}, Q_{req_103}, required to complete tasks falling within the time schedule.

In other words, each of the electrical energy repositories 101, 102, 103 will need a particular level of energy Q_{req_101}, Q_{req_102}, Q_{req_103}, that is started to be drawn from the electrical energy repository at a particular time t_{req_101}, t_{req_102}, t_{req_103}, and until the tasks, falling within the time schedule, are completed. In the example shown in FIG. 2, the task may involve a bus completing a particular rout according to a time schedule.

In one example shown in FIG. 2, the one or more electrical energy repositories 101, 102, 103, are vehicles, or more precisely busses for public transport. Each vehicle is associated with a task to complete a particular geographical route starting at a particular time t_{req_101}, t_{req_102}, t_{req_103}. To complete the route, and any additional transport to/from the route, the vehicles 101, 102, 103 will need a particular level of energy Q_{req_101}, Q_{req_102}, Q_{req_103}.

As can be seen in FIG. 2, each of the vehicle typically need a different level of energy Q_{req_101}, Q_{req_102}, Q_{req_103} to complete its task. To charge every electrical energy repository 101, 102, 103, to full charge each time will result in high peak energy drawn from the grid, and also reduced life span of the electrical energy repositories 101, 102, 103. In the example of electric vehicles, the battery represents a significant part of the total cost of the vehicle, and it is desirable to ensure that the battery lasts for as long as possible.

In other words, as the time when electrical energy repositories 101, 102, 103 in the form of vehicles are typically connected during peak hours, even though many of them are not expected to be used in a relatively long period, this behavior will result in unnecessary high peak energy drawn from the grid. Further, as the typical behavior when charging the vehicles is to charge them to full capacity, even though most are not expected to require the charge energy before being charged again, will reduce life span of the batteries. This is related to the chemical construction of the battery. E.g., the life span of Lithium batteries is reduced if the batteries are constantly charged to full capacity.

Factors influencing life span is further described in the initial part of the detailed description.

In this example, the disclosure increases life span of the repository by charging with a relatively low charging current whilst still achieving a required level of energy Q_{req_101}, Q_{req_102}, Q_{req_103} to complete a scheduled task. In other words, life span is improved by reducing the charging current needed to a minimum and still achieve the required level of energy Q_{req_101}, Q_{req_102}, Q_{req_103}.

Further, a relatively narrow charge and discharge bandwidth is used to increase life span of the battery, e.g., operating the battery with a maximum SoC of 80% and a minimum SoC of 25%.

Further, the present disclosure limits the DoD, e.g., by ensuring that SoC never falls below 25% when providing power from the repository to the grid.

Further, vehicles that are not scheduled to operate for a long time or are scheduled to dwell for a long time are charged to a level well below a SoC of 100%, e.g., 80%, to increase life span of the battery.

The present disclosure addresses the problems mentioned above by considering a level of energy Q_{req_101}, Q_{req_102}, Q_{req_103} for each electrical energy repository 101, 102, 103 required to complete scheduled tasks, as well as considering when the energy is needed. By doing so, the lifespans of the electrical energy repositories are prolonged, at the same time as supporting/relieving the power grid at times of peak demand.

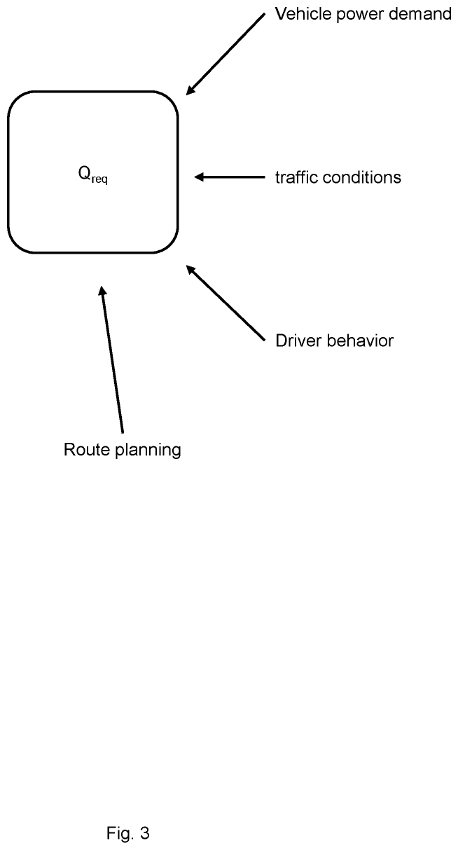

FIG. 3 illustrates examples of characteristics of the one or more electrical energy repositories 101, 102, 103 according to one or more embodiments of the present disclosure. As can be seen in FIG. 3, any number of characteristics may influence the level of energy Q_{req} the energy repository needs to store or hold in order to complete scheduled tasks.

In one example, the one or more electrical energy repositories 101, 102, 103 are vehicles. Each vehicle will typically have a scheduled task to complete a geographical route planning, such as completing one or more bus routes. Each vehicle will have a particular vehicle power demand, e.g., a certain power output of its motors or electrical machines, climate control, lights etc. Each vehicle will experience different traffic conditions such as traffic lights, traffic congestions, hilly sections of road, number of stops etc. Each vehicle will experience different driver behavior, such as acceleration and deceleration behavior of the driver.

Depending on the time schedule associated to each vehicle, the level of energy Q_{req} the energy repository typically needs to be reached at different times for different electrical energy repositories 101, 102, 103.

The required level of energy Q_{req} is in this disclosure modelled using machine learning. The inputs are e.g., route information (such as route length, route altitude change, route index etc.), vehicle power demand (such as power demand to cope with an expected load, power demand for a certain power output of its motors or electrical machines, power demand for climate control, lights etc.), power demand to cope with current traffic conditions (such as traffic lights, traffic congestions, hilly sections of road, number of stops, average vehicle speed on road etc.) and power demand resulting from various driver behavior (such as acceleration and deceleration level of the driver).

The trained model described herein, may in one example be a multiple layer neural network with an input layer/s, one or more hidden layers, and an output layer/s. The output may e.g., be parameters as the predicted required energy Qreq.

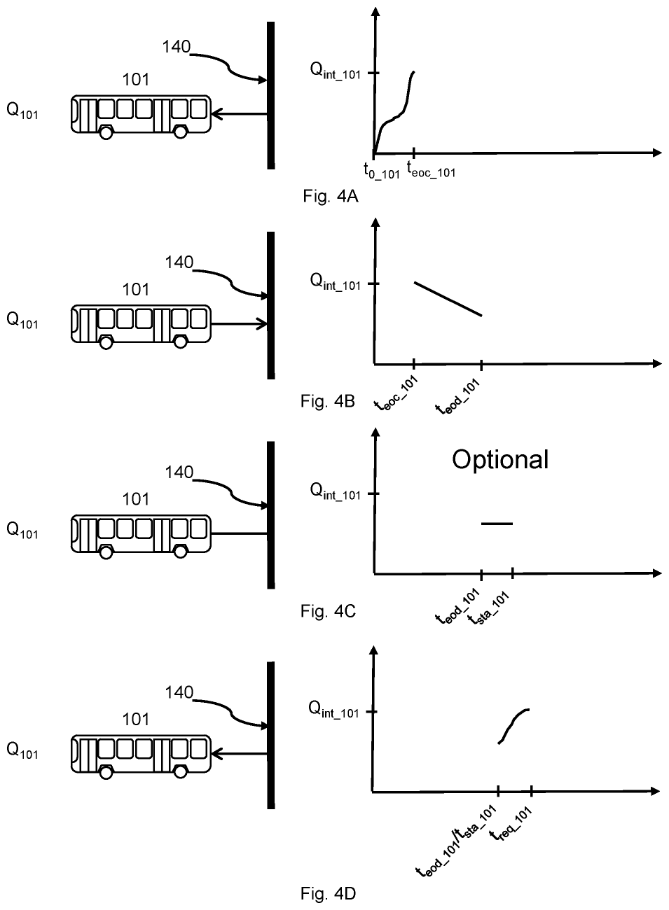

The trained model may be trained to optimize a quality function f. In one example a charging current for the one or more electrical energy repositories will be determined by optimizing the function f, i.e., by solving an optimization question. The objective is to minimize the aging speed of the one or more electrical energy repositories and maximize the profits of energy for vehicle-to-grid, subject to the constraint of energy left at the end of charging at t_req101, t_req 102, t_req_103 being bigger than Q_req, the charging current being smaller than a charging limitation and the energy flowing to the grid being smaller than what the grid needs, and the state of charge (SOC) window being within the limitation of the battery. The optimization also includes the constraints from a battery equivalent circuit model and power price of the grid. The solution of the optimization will lead to different situations depicted in FIG. 4A-D.

In one example, data indicative of charging characteristics, such as charging current and target charging level, is collected with data indicative of determined lifespan of corresponding batteries. Further, data of scheduled tasks, e.g., to complete a geographical route, data indicative of vehicle power demand, traffic conditions and driver behavior are collected.

The collected data can then be used to train a model, e.g., using machine learning techniques. The trained model may e.g., then be used by providing the trained model with a vehicle type, driver, route, and a time when the route should be driven. The trained model may then provide required energy Qreq needed to complete the route, at a particular time, in a particular vehicle by a particular driver.

Further, data indicative of characteristics of the power grid 140 may be collected. E.g., historical consumption of users of the grid 110 which can be used to generate a model indicative of peak consumption of the grid. In other words, the collected data may be used to identify peak hours of the grid when it may be beneficial to draw energy from the one or more electrical energy repositories 101, 102, 103.

FIG. 4A-D schematically illustrates the method according to one or more embodiments of the present disclosure. Training data for one or more electrical energy repositories 101, 102, 103 is initially obtained. The training data comprises a selection of characteristics of the one or more electrical energy repositories 101, 102, 103 and/or characteristics of the power grid 140 as input data. The training data further comprises the level of energy Qreq_101, Qreq_102, Qreq_103 each energy repository needed to complete a predetermined set of scheduled tasks. The training data further comprises, data indicative of charging current, charge and discharge bandwidth, DoD, maximum level of SoC.

In one example, the one or more electrical energy repositories 101, 102, 103 are busses each associated with a time schedule and a geographical route. Historical data indicative of the level of energy Qreq_101, Qreq_102, Qreq_103 each bus needed to complete the predetermined set of scheduled tasks or time schedule and a geographical route is collected or recorded as training data. The vehicle power demand, traffic conditions, driver behavior is also collected or recorded as training data. An example of vehicle power demand in the context of FIG. 4A-D may be a bus having a certain total weight, have a certain power rating and is requiring a particular number of Watts per second. An example of traffic conditions in the context of FIG. 4A-D may be that a bus travelling along roads that is congested to various extents over time, and an average speed of vehicles travelling on that road indicates a level of congestion. An example of traffic conditions in the context of FIG. 4A-D may be that a bus travelling along roads that have varying number of traffic lights, and the vehicle will be involved in any number of starts/stops when completing a particular route. An example of driver behavior in the context of FIG. 4A-D may be that measurements of vehicle acceleration when a particular driver is handling the vehicle indicates that the driver has an aggressive, normal, or soft driver behavior. E.g., historical data of recorded acceleration when a vehicle travels a particular route. Statistical measures may also be applied to the recorded acceleration, e.g., maximum, median, or average acceleration.

The training data is then used to generate a trained model. The trained model will typically be provided with a scheduled task and type of electrical energy repository, e.g., a time schedule, a geographical route and type of vehicle to be used.

To generate or train a model may in one example comprises to optimize a multi-layer neural network. A neural network is typically defined as a computing system that comprise a number of interconnected elements or nodes, often referred to as “neurons”. The neurons are organized in layers which process information using dynamic state responses to external inputs. Each connection between neurons is provided with a weight. Multiple sets of candidate weights are evaluated using a performance measure for the model.

Typically, one subset of historical data or training data and known responses are used to optimize the weights for a trained model, and the remaining set of historical data or training data is used to verify the trained model.

In one example, historical data indicative of time schedules, routes, vehicle power demand, traffic conditions, driver behavior for a fleet of busses are collected as training data. At the same time the required level of energy used to complete the tasks or routes are recorded. This means that characteristics of the one or more electrical energy repositories 101, 102, 103, characteristics of the power grid and the set of parameters, such as required energy level Qreq_101, Qreq_102, Qreq_103 of respective internal loads, are recorded. The characteristics and the set of parameters are then used to optimize weights in the neural network, and to train the model.

The trained model then determines a set of parameters as output data. The set of parameters may, for each of the one or more electrical energy repositories 101, 102, 103, comprise a selection of any of:
a first threshold level of energy Qint_101, Qint_102, Qint_103. The first threshold level of energy may e.g., be a first target level of charge of a battery in a vehicle.
a second threshold level of energy Qreq_101, Qreq_102, Qreq_103, indicative of energy required by the respective internal load of the electrical energy repository, typically to complete one or more scheduled tasks.
first time teoc_101 indicative of when the respective first threshold level of energy Qint_101, Qint_102, Qint_103 is reached and/or indicative of when energy is expected to be drawn from the one or more electrical energy repositories 101, 102, 103 to the power grid 140. The first time may e.g., be a point in time after the first target level of charge of a battery in the vehicle had been reached and before the start of a time schedule and planned geographical route of the vehicle.
a second time trec_101, trec_102, trec_103, indicative of when energy is expected to be drawn from the one or more electrical energy repositories 101, 102, 103 to the respective internal load. The second time may e.g., be the start of a time schedule and planned geographical route to be travelled the vehicle.
a third time indicative of a target time, teod, for ending the flow of energy to the power grid 140 from the one or more electrical energy repositories 101, 102, 103. The third time is typically located before/earlier than the second time.
a fourth time indicative of a target time, tsta, for re-initiating charge, for each of the one or more electrical energy repositories 101, 102, 103. I.e., after drawing energy from the electrical energy repository to the grid 140, it must be secured that the energy level is restored so that any scheduled tasks can be completed.

In one example, the second time trec_101, trec_102, trec_103 is given by a time schedule for a particular route or bus line. The trained model can then provide at least the second threshold level of energy Qreq_101, Qreq_102, Qreq_103.

In one further example, the electrical energy repository is a vehicle. The characteristics of the electrical energy repository include vehicle characteristics. The characteristics of the power grid indicates that peak power consumption happens at certain times, and the trained model can use this information to determine the first time teoc_101, teoc_102, teoc_103 and/or the first threshold level of energy Qint_101, Qint_102, Qint_103. In other words, interrupting charge of the energy repository to provide energy to the power grid in a peak hour/during peak demand. The trained model further provides the third time indicative of a target time, teod, indicative of the end of the peak hour/during peak demand and the fourth time indicative of a target time, tsta, for re-initiating charge to the second threshold level of energy Qreq_101, Qreq_102, Qreq_103.

In one further example, the electrical energy repository is an energy buffer/accumulator pack 130.

The characteristics of the electrical energy repository include electrical energy repository characteristics. For example, characteristics of the electrical energy repository may comprise, vehicle power demand, traffic conditions, driver behavior, route planning as shown in FIG. 3. Characteristics of the electrical energy repository may further comprise maximum capacity of the repository, maximum charging current of the repository etc.

The characteristics of the power grid indicates that peak power consumption happens at certain times, and the trained model can use this information to determine the first time teoc_101 and/or the first threshold level of energy Qint_101. In other words, interrupting charge of the energy repository to provide energy to the power grid in a peak hour/during peak demand. In other words, the energy buffer/accumulator pack 130 is not necessarily associated with a second threshold level of energy Qreq_101, Qreq_102, Qreq_103.

FIG. 4A illustrates charging of an electrical energy repository to a first level or threshold level of energy Qint_101 according to one or more embodiments of the present disclosure. At a starting point in time t0_101, the electrical energy repository 101 is typically connected to the power grid for charging. The charging continues until a subsequent point in time teoc_101, when the charge is ended and/or when the respective first threshold level of energy Qint_101 is reached. The flow of energy is illustrated by the arrow between the power grid 140 and the electrical energy repository 101.

The repositories 101, 102, 103 are charged or controlled to be charged using a determined set of parameters. These parameters may comprise charging current, charge and discharge bandwidth, DoD, maximum/minimum level of SoC.

The energy is drawn from the power grid 140 to charge the one or more electrical energy repositories 101, 102, 103. The one or more electrical energy repositories 101, 102, 103 are charged to a respective first threshold level of energy Qint_101, Qint_102, Qint_103. The first respective threshold level of energy Qint_101, Qint_102, Qint_103 is indicated by the set of parameters.

As mentioned in the initial part of the description, the starting point in time to, the first time teoc_101 and the first threshold level of energy Qint_101 may be selected to limits the DoD, to select a relatively narrow charge and discharge bandwidth is used to increase life span of the battery, e.g., operating the battery with a maximum SoC of 80% and a minimum SoC of 25% instead of operating the battery with a maximum SoC of 100% and a minimum SoC of 50%, which is common in conventional solutions. In one further example, the battery temperature is kept below 30° C. to increase life span of the battery, e.g., by limiting charging current to a normal/healthy charging current. The faster the battery is charged (relatively high charging current, the more heat is generated in the cells of the battery. In one further example, charging the battery to high levels of SoC is avoided if it is known that the vehicle will dwell for a long time. For example, knowing that a vehicle is not scheduled to operate for a longer period.

FIG. 4B illustrates energy drawn from an electrical energy repository 101 to the power grid 140.

At this step, energy is drawn from the electrical energy repository 101 to the power grid 140. The flow of energy is illustrated by the arrow between the power grid 140 and the electrical energy repository 101. The flow of energy may be initiated immediately after the charge is ended and/or when the respective first threshold level of energy Qint_101, Qint_102, Qint_103 is reached, or may be initiated with some delay.

In one example, energy is drawn from an electrical energy repository to the power grid during a peak demand period of the power grid. In this operating state where energy is drawn from an electrical energy repository to the power grid, the present disclosure improves the life span of the battery primarily by using relatively narrow charge and discharge bandwidth and by limiting DoD.

FIG. 4C illustrates an optional step of waiting or delaying a predetermined time before proceeding to the next step. I.e., no flow of energy between the power grid 140 and the electrical energy repository 101 occurs.

FIG. 4D illustrates re-initiating charging of the electrical energy repository 101 using the set of parameters. These parameters may comprise charging current, charge and discharge bandwidth, DoD, maximum/minimum level of SoC.

In this example, the disclosure increases life span of the repository 101 by charging with a relatively low charging current whilst still achieving a required level of energy Q_{req_101}, Q_{req_102}, Q_{req_103} to complete a scheduled task. In other words, life span is improved by reducing the charging current needed to a minimum and still achieve the required level of energy Q_{req_101}, Q_{req_102}, Q_{req_103}.

Further, a relatively narrow charge and discharge bandwidth is used to increase life span of the repository/battery, e.g., operating the repository/battery with a maximum SoC of 80% and a minimum SoC of 25%.

Further, where the repositories are vehicles, and the vehicles are not scheduled to operate for a long time or are scheduled to dwell for a long time, the repositories are charged to a level well below a SoC of 100%, e.g., 80%, to increase life span of the battery. This will increase the number of discharge/charge cycles with a minimum performance the repository will provide.

Energy is here drawn from the power grid 140 to charge the electrical energy repository 101. I.e., the repository 101 is electrically coupled to the power grid 140. The electrical energy repository 101 is charged to the respective second threshold level of energy Qreq_101 in a second period between the respective fourth time tsta to the corresponding second time trec_101. The flow of energy is illustrated by the arrow between the power grid 140 and the electrical energy repository 101.

In one example, energy is charged to an electrical energy repository from the power grid after the peak demand period of the power grid has passed. It is understood that the respective first threshold level of energy Qint_101 may be reached before the respective fourth time tsta. Thus, charging may be terminated before the respective fourth time tsta.

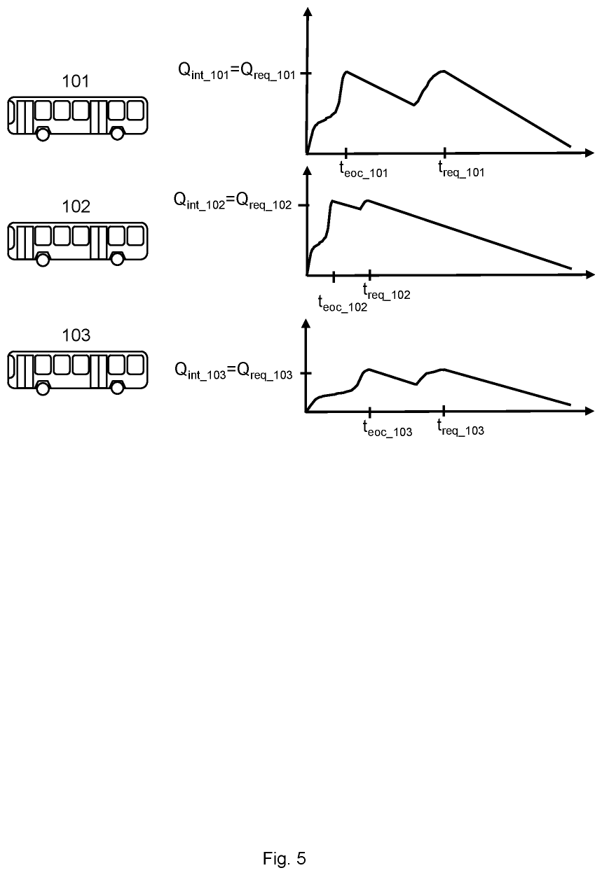

FIG. 5 illustrates an embodiment where the first threshold level of energy Qint_101, Qint_102, Qint_103 is selected equal to the second threshold level of energy Qreq_101, Qreq_102, Qreq_103. In other words, the one or more electrical energy repositories 101, 102, 103 are first charged to a respective energy level required by the respective internal load Qreq_101, Qreq_102, Qreq_103. Energy may then be provided to the power grid, e.g., during peak hours.

Charging is then re-initiated to replace the energy that flowed to the power grid, and restore the one or more electrical energy repositories 101, 102, 103 to a respective energy level Qreq_101, Qreq_102, Qreq_103 required by the respective internal load.

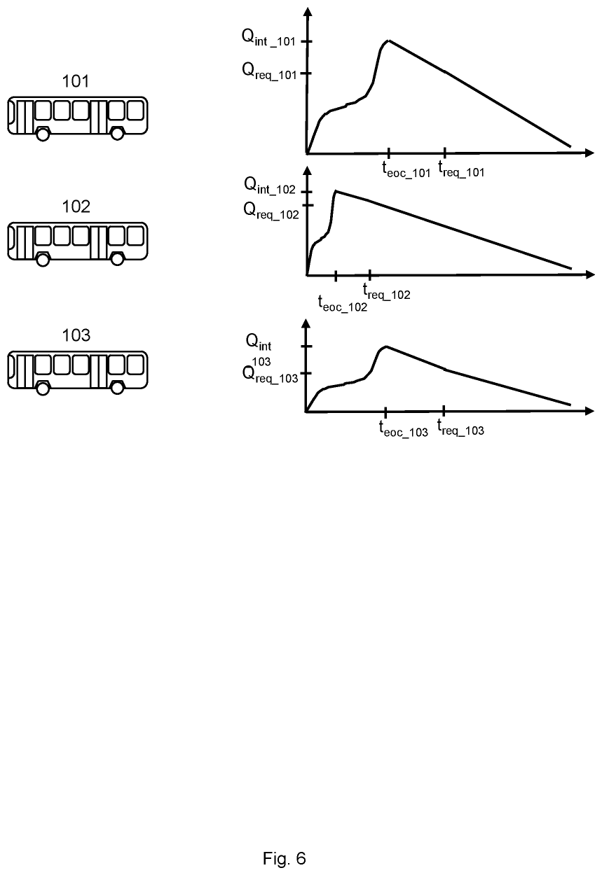

FIG. 6 illustrates an embodiment where the first threshold level of energy Qint_101, Qint_102, Qint_103 is selected greater than the second threshold level of energy Qreq_101, Qreq_102, Qreq_103. In other words, the one or more electrical energy repositories 101, 102, 103 are first charged to a higher energy level required by the respective internal load Qreq_101, Qreq_102, Qreq_103. Energy may then be provided to the power grid, e.g., during peak hours. The amount of energy drawn to the power grid 140 brings the one or more electrical energy repositories 101, 102, 103 down to the respective energy level Qreq_101, Qreq_102, Qreq_103 required by the respective internal load. This may be particularly helpful if a peak hour of the power grid occurs close to the respective second time trec_101, trec_102, trec_103 when energy is expected to be drawn from the one or more electrical energy repositories (101, 102, 103) to the respective internal load.

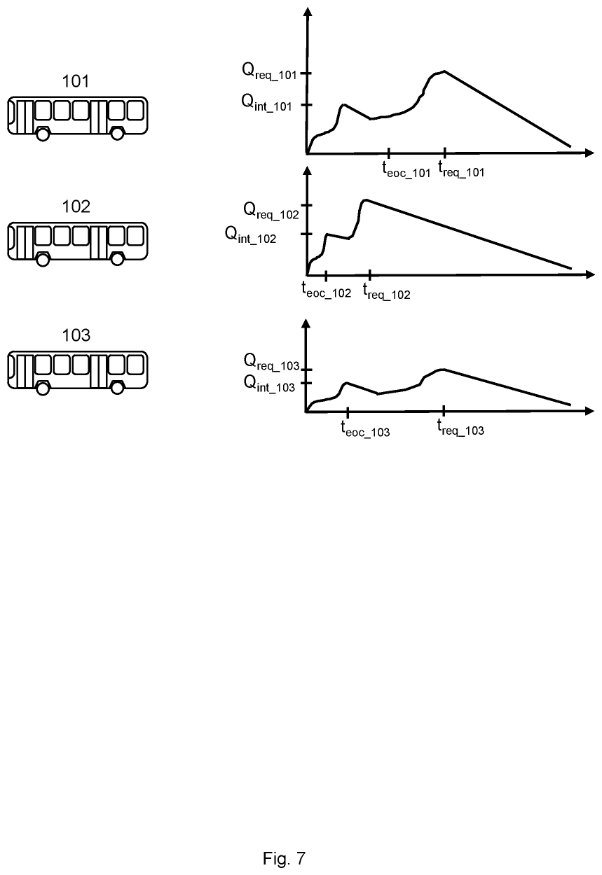

FIG. 7 illustrates an embodiment where the first threshold level of energy Qint_101, Qint_102, Qint_103 is selected less than the second threshold level of energy Qreq_101, Qreq_102, Qreq_103. In other words, the one or more electrical energy repositories 101, 102, 103 are first charged to a lower energy level then the energy level required by the respective internal load Qreq_101, Qreq_102, Qreq_103. Energy may then be provided to the power grid, e.g., during peak hours. Charging is then re-initiated to replace the energy that flowed to the power grid and charge the one or more electrical energy repositories 101, 102, 103 to a respective energy level Qreq_101, Qreq_102, Qreq_103 required by the respective internal load. This may be particularly helpful if a peak hour of the power grid occurs close to the respective starting point in time when the electrical energy repository 101 is initially connected to the power grid for charging, typically when becoming stationary, e.g., when arriving to a garage.

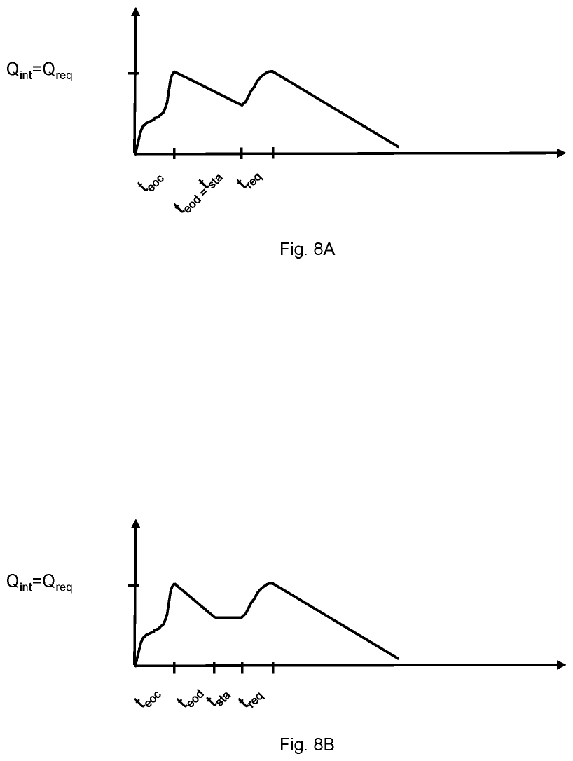

FIG. 8A illustrates an embodiment without delay between the flow of energy from an electrical energy repository to the power grid 140. As can be seen from FIG. 8A, charging is immediately re-initiated after drawing energy from the repository to the power grid 140. In this embodiment, the third time indicative of the target time teod for ending the flow of energy to the power grid 140 is, under practical circumstances, equal to the fourth time indicative of a target time tsta for re-initiating charge.

FIG. 8B illustrates an embodiment with delay between the flow of energy from an electrical energy repository to the power grid 140. As can be seen from FIG. 8B, charging is re-initiated with a delay after drawing energy from the repository to the power grid 140. In this embodiment, the third time indicative of the target time teod for ending the flow of energy to the power grid 140 is different than the fourth time indicative of a target time tsta for re-initiating charge.

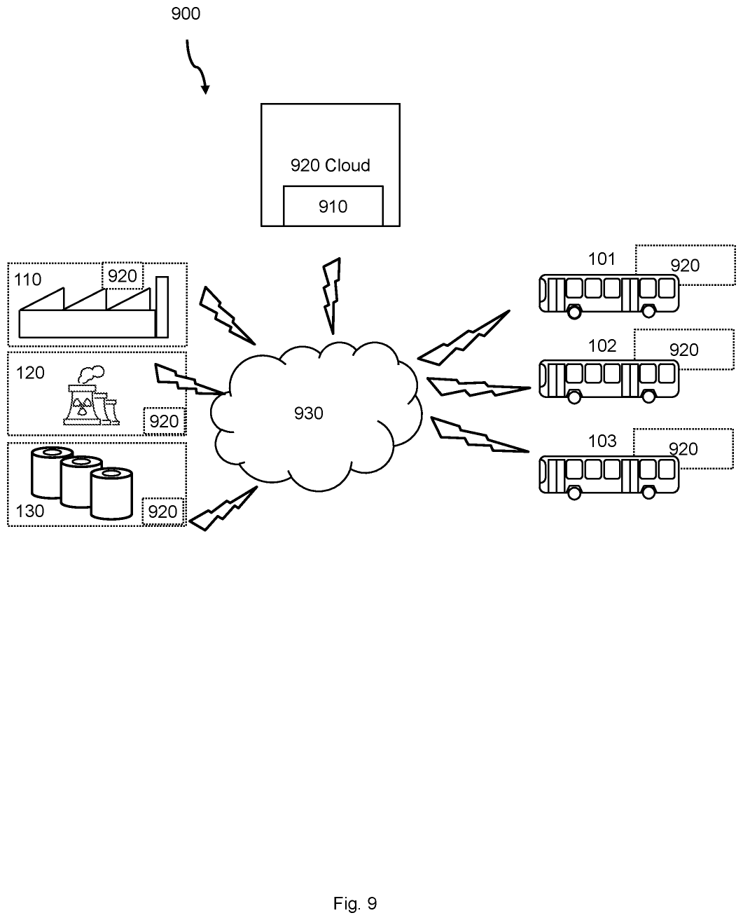

FIG. 9 illustrates a control system 900 for controlling a flow of electrical energy between one or more electrical energy repositories 101, 102, 103, 130 and a power grid 140. The system may comprise a selection of any of energy consumer units 110, energy generator units 120 and one or more electrical energy repositories 101, 102, 103, 130 electrically coupled to the power grid 140 and optionally communicatively coupled to each other via a communications network 930. The electrical energy repositories 101, 102, 103, 130 may e.g., be electrical vehicles 101-103 provided with batteries or accumulator packs 130. The control system 900 further comprises one or more control units 920 configured to perform all or a selection of the method steps described herein. In FIG. 9, the control unit 920 is shown as a separate cloud server, but the control unit/s may be comprised in any of the other units, e.g., the one or more electrical energy repositories 101, 102, 103, 130.

Messages may be broadcasted via the communications network or exchanged between two nodes directly.

In one example, a control unit 920 comprising or comprised by a cloud server, collects training data, e.g., from vehicles and from the power grid 140, and generates a trained model. The trained model is sent in messages to supply units/chargers configured to charge the electrical energy repositories 101, 102, 103, 130, e.g., vehicles 101, 102, 103. The trained model is then used by the to supply units/chargers to determine the set of parameters used to control charging of the electrical energy repositories 101, 102, 103, 130. The charging of the electrical energy repositories 101, 102, 103, 130 are then controlled using the determined set of parameters, as described herein.

In one further example, a control unit 920 comprising or comprised by a cloud server, collects training data from the power grid 140 and generates a trained model. The trained model is sent in messages to the electrical energy repositories, e.g., vehicles 101, 102, 103. The trained model is then used by the electrical energy repositories to determine the set of parameters used to control charging. The charging of the electrical energy repositories 101, 102, 103, 130 are then controlled using the determined set of parameters, as described herein.

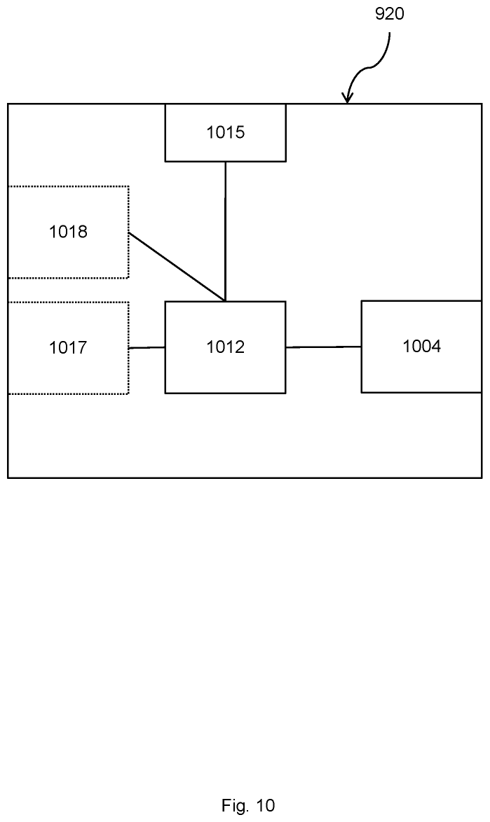

FIG. 10 shows a control unit 920 according to one or more embodiments of the present disclosure. The control unit 920 may e.g., be in the form of an Electronic Control Unit, a server, an on-board computer, a vehicle mounted computer system or a navigation device. The control unit 920 may comprise a processor or processing means 1012 communicatively coupled to a transceiver 1004 configured for wired or wireless communication. Further, the control unit 920 may further comprise at least one optional antenna (not shown in figure). The antenna may be coupled to the transceiver 1004 and is configured to transmit and/or emit and/or receive wireless signals in a wireless communication system, e.g., wireless signals comprising road traffic event data. In one example, the processor 1012 may be any of a selection of processing circuitry and/or a central processing unit and/or processor modules and/or multiple processors configured to cooperate with each-other. Further, the control unit 920 may further comprise a memory 1015. The memory 1015 may contain instructions executable by the processor to perform any of the methods described herein. The memory and/or computer-readable storage medium referred to herein may comprise of essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

In a further embodiment, the control unit 920 may further comprise and/or be coupled to one or more sensors configured to e.g., receive and/or obtain and/or measure physical properties pertaining to the charging system 900 and send one or more sensor signals indicative of the physical properties to the processing means 1012.

In one or more embodiments the control unit 920 may further comprise an input device 1017, configured to receive input or indications from a user and send a user-input signal indicative of the user input or indications to the processor or processing means 1012.

In one or more embodiments the control unit 920 may further comprise a display 1018 configured to receive a display signal indicative of rendered objects, such as text or graphical user input objects, from the processor or processing means 1012 and to display the received signal as objects, such as text or graphical user input objects.

In one embodiment the display 1018 is integrated with the user input device 1017 and is configured to receive a display signal indicative of rendered objects, such as text or graphical user input objects, from the processing means 1012 and to display the received signal as objects, such as text or graphical user input objects, and/or configured to receive input or indications from a user and send a user-input signal indicative of the user input or indications to the processing means 1012.

In embodiments, the processing means 1012 is communicatively coupled to a selection of any of the memory 1015 and/or the communications interface and/or transceiver and/or the input device 1017 and/or the display 1018 and/or the one or more sensors. In embodiments, the transceiver 1004 communicates using wired and/or wireless communication techniques. The wired or wireless communication techniques may comprise any of a CAN bus, Bluetooth, WiFi, GSM, UMTS, LTE or LTE advanced communications network or any other wired or wireless communication network known in the art.

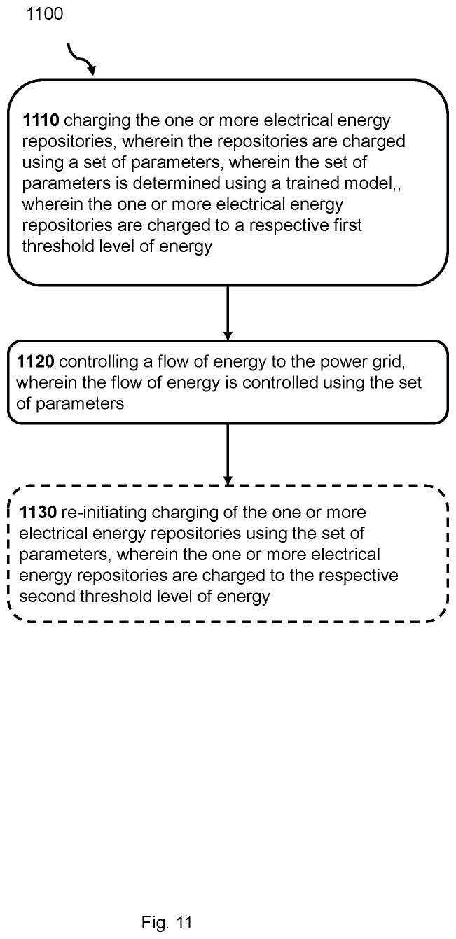

FIG. 11 shows a flowchart of a method 1100 for controlling a flow of electrical energy between one or more electrical energy repositories 101, 102, 103 and a power grid 140 according to one or more embodiments of the present disclosure. The method is performed by a control unit. Each of the one or more electrical energy repositories 101, 102, 103 is electrically coupled to a respective internal load. The method comprising:

Step 1110: charging the one or more electrical energy repositories 101, 102, 103. Charging in this context typically comprises controlling charge of the one or more electrical energy repositories 101, 102, 103. E.g., controlling when at which magnitude voltage and/or current is provided to the one or more electrical energy repositories 101, 102, 103. The one or more electrical energy repositories 101, 102, 103 are charged using/based on a set of parameters. Energy is drawn from the power grid 140 to charge the one or more electrical energy repositories 101, 102, 103. The one or more electrical energy repositories 101, 102, 103 are charged to a respective first threshold level of energy Qint_101, Qint_102, Qint_103. The first respective threshold level of energy Qint_101, Qint_102, Qint_103 is indicated by the set of parameters.

These parameters may e.g., comprise charging current, charge and discharge bandwidth, DoD, maximum/minimum level of SoC.

In one embodiment, the set of parameters is determined using a trained model. Additionally, or alternatively, the model being trained using deep learning machine learning techniques or any other suitable machine learning techniques.

Step 1120: controlling a flow of energy to the power grid 140. The flow of energy is controlled using the set of parameters. The energy is drawn from any of the one or more electrical energy repositories 101, 102, 103 to the power grid 140. Energy is drawn from any of the energy repositories 101, 102, 103 in a first period between a respective first time teoc_101, teoc_102, teoc_103, indicative of when the respective first threshold level of energy Qint_101, Qint_102, Qint_103 is reached, and a respective second time trec_101, trec_102, trec_103, indicative of when energy is expected to be drawn from the one or more electrical energy repositories 101, 102, 103 to the respective internal load.

The set of parameters is determined using a trained model. The model may e.g., be trained using deep learning machine learning techniques. The training of the trained model comprises to calculate the parameters using backpropagation.

The steps 1110 and 1120 are further described in relation to FIG. 4A and FIG. 4B.

In one embodiment, the trained model is trained using training data indicative of characteristics of the one or more electrical energy repositories 101, 102, 103. The characteristics of the one or more electrical energy repositories 101, 102, 103 are further described in relation to FIG. 3. The determined set of parameters further includes at least a respective second threshold level of energy Qreq_101, Qreq_102, Qreq_103 indicative of energy required by the respective internal load. The second threshold level of energy Qreq_101, Qreq_102, Qreq_103 is further described in relation to FIG. 2.

Additionally, or alternatively, the trained model is trained further using training data indicative of characteristics of the power grid 140. The characteristics of the power grid 140 includes at least electrical energy utilization of the power grid 140 over time. In particular, the characteristics of the power grid 140 identifies peak hours with the highest utilization of the power grid 140.

In one embodiment, the electrical energy repositories 101, 102, 103 comprises vehicles. The vehicles are provided with batteries for storing electrical energy, and are provided with internal loads in the form of electrical drive units configured to drive the vehicle using the batteries. The trained model is further trained using data indicative of characteristics of the vehicles, such as vehicle power demand.

Additionally, or alternatively, the characteristics of the vehicles comprises at least data indicative of a selection of any of a battery model, power demand of the electrical drive unit, traffic conditions for the vehicle, behavior of the driver of the vehicle, geographical route of the vehicle.

In one embodiment, the determined set of parameters further comprises:
the first time, and the second time, and optionally a third time indicative of a target time teod for ending the flow of energy to the power grid 140, and/or a fourth time indicative of a target time tsta for re-initiating charge, for each of the one or more electrical energy repositories 101, 102, 103.

Additionally, or alternatively, the method further comprises:

Step 1130: re-initiating charging of the one or more electrical energy repositories 101, 102, 103 using the set of parameters, wherein energy is drawn from the power grid 140 to charge the one or more electrical energy repositories 101, 102, 103. The one or more electrical energy repositories 101, 102, 103 are charged to the respective second threshold level of energy Qreq_101, Qreq_102, Qreq_103. The one or more electrical energy repositories 101, 102, 103 are charged in a second period between the respective fourth time tsta to the respective second time trec, trec_101, trec_102, trec_103.

In one embodiment, charging is re-initiated directly when the flow of energy to the power grid 140 has ended. Additionally, or alternatively, the fourth time tsta is determined equal to the third time teod, teod_101.

In one embodiment, charging is re-initiated with a delay after the flow of energy to the power grid 140 has ended. Additionally, or alternatively, the fourth time tsta is determined with a delay relative to the third time teod, teod_101.

In one embodiment, the first and second threshold level of energy are determined to the same value. In this embodiment, the first respective threshold level of energy Qint_101, Qint_102, Qint_103 is determined, in practical circumstances, equal to the respective second threshold level of energy Qreq_101, Qreq_102, Qreq_103.

In one embodiment, a computer program is provided comprising computer-executable instructions for causing the road traffic event control unit 920 when the computer-executable instructions are executed on a processing unit comprised in the control unit 920, to perform any of the methods described herein.

In one embodiment, a computer program product is provided comprising a computer-readable storage medium, the computer-readable storage medium having the computer program above embodied therein.

In one embodiment, a carrier comprising the computer program above, wherein the carrier is one of an electronic signal, optical signal, radio signal, or computer readable storage medium.

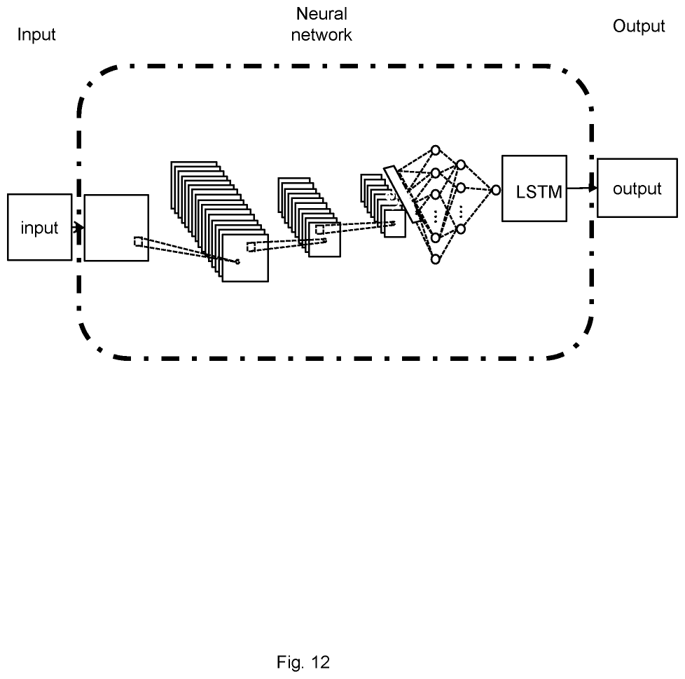

FIG. 12 illustrates a trained model according to one or more embodiments of the present disclosure. As can be seen in FIG. 12 the trained model is a neural network with an input layer, an output layer and one or more layers.

The input layer inputs may e.g., be instant/live traffic data and conditional data, such as traffic flow, traffic density of roads, weather conditions, driving behavior for large amounts of vehicles, route planning information from navigation system of large amounts of vehicles, vehicle power demand of large amounts of vehicles and so on. The neural network takes these inputs and pass them through layers a network (in this example, a convolutional network), and send the abstracted feature to LSTM (long short term memory). The naming of deep network relates to the fact that the neural network comprises many layers of neurons which makes the network deep. The LSTM is a kind of recurrent network for time series. The summary of deep network can predict both seasonal and hourly change of the required energy for the vehicle Qreq.

The deep network can also be used to model the power price and demand of the utility electricity grid, typically comprising factories, electricity power plan and residence usage and so on. The input will be the electricity usage or demand of all these resources coupled to the utility electricity grid.

With an accurate prediction of power demand of electrical vehicle, the optimization can make optimized charging of the vehicle, such as taking slow charging if the required energy for the next trip is very low, or when the departure time significantly later than nominal/expected finish charging time when using a normal charging current. In this way the battery life length will be extended significantly.

In embodiments, the communications network 930 communicate using wired or wireless communication techniques that may include at least one of a Local Area Network (LAN), Metropolitan Area Network (MAN), Global System for Mobile Network (GSM), Enhanced Data GSM Environment (EDGE), Universal Mobile Telecommunications System, Long term evolution, High Speed Downlink Packet Access (HSDPA), Wideband Code Division Multiple Access (W-CDMA), Code Division Multiple Access (CDMA), Time Division Multiple Access (TDMA), Bluetooth®, Zigbee®, Wi-Fi, Voice over Internet Protocol (VoIP), LTE Advanced, IEEE802.16m, WirelessMAN-Advanced, Evolved High-Speed Packet Access (HSPA+), 3GPP Long Term Evolution (LTE), Mobile WiMAX (IEEE 802.16e), Ultra Mobile Broadband (UMB) (formerly Evolution-Data Optimized (EV-DO) Rev. C), Fast Low-latency Access with Seamless Handoff Orthogonal Frequency Division Multiplexing (Flash-OFDM), High Capacity Spatial Division Multiple Access (iBurst®) and Mobile Broadband Wireless Access (MBWA) (IEEE 802.20) systems, High Performance Radio Metropolitan Area Network (HIPERMAN), Beam-Division Multiple Access (BDMA), World Interoperability for Microwave Access (Wi-MAX) and ultrasonic communication, etc., but is not limited thereto.

Moreover, it is realized by the skilled person that the control unit 920 may comprise the necessary communication capabilities in the form of e.g., functions, means, units, elements, etc., for performing the present solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, encoder, decoder, power supply units, power feeders, communication interfaces, communication protocols, etc. which are suitably arranged together for performing the present solution.

Especially, the processor and/or processing means of the present disclosure may comprise one or more instances of processing circuitry, processor modules and multiple processors configured to cooperate with each-other, Central Processing Unit (CPU), a processing unit, a processing circuit, a processor, an Application Specific Integrated Circuit (ASIC), a microprocessor, a Field-Programmable Gate Array (FPGA) or other processing logic that may interpret and execute instructions. The expression “processor” and/or “processing means” may thus represent a processing circuitry comprising a plurality of processing circuits, such as, e.g., any, some or all of the ones mentioned above. The processing means may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

1. A method performed by a control unit for controlling a flow of electrical energy between one or more electrical energy repositories and a power grid, wherein each of the one or more electrical energy repositories is electrically coupled to a respective internal load, the method comprising:
charging the one or more electrical energy repositories, wherein the repositories are charged based on a set of parameters, wherein energy is drawn from the power grid to charge the one or more electrical energy repositories, wherein the one or more electrical energy repositories are charged to a respective first threshold level of energy, wherein the first respective threshold level of energy is indicated by the set of parameters; and
controlling a flow of energy to the power grid, wherein the flow of energy is controlled using the set of parameters, wherein energy is drawn from any of the one or more electrical energy repositories to the power grid, wherein energy is drawn from any of the energy repositories in a first period between a respective first time, indicative of when the respective first threshold level of energy is reached, and a respective second time, indicative of when energy is expected to be drawn from the one or more electrical energy repositories to the respective internal load,
wherein the set of parameters is determined using a trained model.

2. The method according to claim 1, wherein the trained model is trained using training data indicative of characteristics of the one or more electrical energy repositories, wherein the determined set of parameters further includes at least a respective second threshold level of energy indicative of energy required by the respective internal load.

3. The method according to claim 2, wherein the trained model is trained further using training data indicative of characteristics of the power grid, wherein the characteristics of the power grid includes at least electrical energy utilization of the power grid over time.

4. The method according to claim 1, wherein the one or more electrical energy repositories comprises one or more vehicles, wherein the vehicles are provided with batteries for storing electrical energy and are provided with internal loads in the form of electrical drive units configured to drive the vehicle using the batteries, wherein the trained model is further trained using data indicative of characteristics of the one or more vehicles.

5. The method according to claim 4, wherein characteristics of the one or more vehicles comprises at least one of: data indicative of a selection of any of battery models, power demand of electrical drive units, traffic conditions for the vehicles, behavior of the drivers of the vehicles, or geographical routes of the vehicles.

6. The method according to claim 1, wherein the determined set of parameters further comprises:
the first time; and
the second time; and
a third time indicative of a target time for ending the flow of energy to the power grid; and/or
a fourth time indicative of a target time for re-initiating charge,
for each of the one or more electrical energy repositories.

7. The method according to claim 6, wherein the method further comprises re-initiating charging of the one or more electrical energy repositories using the set of parameters, wherein energy is drawn from the power grid to charge the one or more electrical energy repositories, wherein the one or more electrical energy repositories are charged to the respective second threshold level of energy in a second period between the respective fourth time to the corresponding second time.

8. The method according to claim 7, wherein the fourth time is determined equal to the third time.

9. The method according to claim 7, wherein the fourth time is determined with a delay relative to the third time.

10. The method according to claim 2, wherein the first respective threshold level of energy is determined equal to the respective second threshold level of energy.

11. A control unit configured to control flow of electrical energy between one or more electrical energy repositories and a power grid, wherein each of the one or more electrical energy repositories is electrically coupled to a respective internal load, the control unit comprising:
a processor; and
a memory, said memory containing instructions executable by said processor to perform the following operations:
charging the one or more electrical energy repositories, wherein the repositories are charged based on a set of parameters, wherein energy is drawn from the power grid to charge the one or more electrical energy repositories, wherein the one or more electrical energy repositories are charged to a respective first threshold level of energy, wherein the first respective threshold level of energy is indicated by the set of parameters; and
controlling a flow of energy to the power grid, wherein the flow of energy is controlled using the set of parameters, wherein energy is drawn from any of the one or more electrical energy repositories to the power grid, wherein energy is drawn from any of the energy repositories in a first period between a respective first time, indicative of when the respective first threshold level of energy is reached, and a respective second time, indicative of when energy is expected to be drawn from the one or more electrical energy repositories to the respective internal load,
wherein the set of parameters is determined using a trained model.

12. The control unit according to claim 1, further comprising a transceiver communicatively coupled to a communications network and configured exchange messages at least with one or more other units electrically coupled to the power grid.

13. A vehicle comprising a control unit configured to control flow of electrical energy between one or more electrical energy repositories and a power grid, wherein each of the one or more electrical energy repositories is electrically coupled to a respective internal load, the control unit comprising:
a processor; and
a memory, said memory containing instructions executable by said processor to perform the following operations:
charging the one or more electrical energy repositories, wherein the repositories are charged based on a set of parameters, wherein energy is drawn from the power grid to charge the one or more electrical energy repositories, wherein the one or more electrical energy repositories are charged to a respective first threshold level of energy, wherein the first respective threshold level of energy is indicated by the set of parameters; and
controlling a flow of energy to the power grid, wherein the flow of energy is controlled using the set of parameters, wherein energy is drawn from any of the one or more electrical energy repositories to the power grid, wherein energy is drawn from any of the energy repositories in a first period between a respective first time, indicative of when the respective first threshold level of energy is reached, and a respective second time, indicative of when energy is expected to be drawn from the one or more electrical energy repositories to the respective internal load,
wherein the set of parameters is determined using a trained model.

14. A supply equipment, comprising a control unit configured to control flow of electrical energy between one or more electrical energy repositories and a power grid, wherein each of the one or more electrical energy repositories is electrically coupled to a respective internal load, the control unit comprising:
a processor; and
a memory, said memory containing instructions executable by said processor to perform the following operations:
charging the one or more electrical energy repositories, wherein the repositories are charged based on a set of parameters, wherein energy is drawn from the power grid to charge the one or more electrical energy repositories, wherein the one or more electrical energy repositories are charged to a respective first threshold level of energy, wherein the first respective threshold level of energy is indicated by the set of parameters; and
controlling a flow of energy to the power grid, wherein the flow of energy is controlled using the set of parameters, wherein energy is drawn from any of the one or more electrical energy repositories to the power grid, wherein energy is drawn from any of the energy repositories in a first period between a respective first time, indicative of when the respective first threshold level of energy is reached, and a respective second time, indicative of when energy is expected to be drawn from the one or more electrical energy repositories to the respective internal load,
wherein the set of parameters is determined using a trained model.

15. A cloud server comprising the control unit configured to control flow of electrical energy between one or more electrical energy repositories and a power grid, wherein each of the one or more electrical energy repositories is electrically coupled to a respective internal load, the control unit comprising:
a processor; and
a memory, said memory containing instructions executable by said processor to perform the following operations:
charging the one or more electrical energy repositories, wherein the repositories are charged based on a set of parameters, wherein energy is drawn from the power grid to charge the one or more electrical energy repositories, wherein the one or more electrical energy repositories are charged to a respective first threshold level of energy, wherein the first respective threshold level of energy is indicated by the set of parameters; and
controlling a flow of energy to the power grid, wherein the flow of energy is controlled using the set of parameters, wherein energy is drawn from any of the one or more electrical energy repositories to the power grid, wherein energy is drawn from any of the energy repositories in a first period between a respective first time, indicative of when the respective first threshold level of energy is reached, and a respective second time, indicative of when energy is expected to be drawn from the one or more electrical energy repositories to the respective internal load,
wherein the set of parameters is determined using a trained model.

16. (canceled)

17. A computer program product stored on a non-transitory computer-readable storage medium, said computer program product to control flow of electrical energy between one or more electrical energy repositories and a power grid, wherein each of the one or more electrical energy repositories is electrically coupled to a respective internal load, said computer program product comprising computer instructions to cause one or more electronic control units or computers to perform the following operations:
charging the one or more electrical energy repositories, wherein the repositories are charged based on a set of parameters, wherein energy is drawn from the power grid to charge the one or more electrical energy repositories, wherein the one or more electrical energy repositories are charged to a respective first threshold level of energy, wherein the first respective threshold level of energy is indicated by the set of parameters; and
controlling a flow of energy to the power grid, wherein the flow of energy is controlled using the set of parameters, wherein energy is drawn from any of the one or more electrical energy repositories to the power grid, wherein energy is drawn from any of the energy repositories in a first period between a respective first time, indicative of when the respective first threshold level of energy is reached, and a respective second time, indicative of when energy is expected to be drawn from the one or more electrical energy repositories to the respective internal load,
wherein the set of parameters is determined using a trained model.
